(19) United States
(12) Patent Application Publication
(10) Pub. No.: US 2009/0276702 A1
(43) Pub. Date: Nov. 5, 2009

(54) METHOD AND APPARATUS FOR BROWSING ITEM INFORMATION AND RECORDING MEDIUM USING THE SAME

(75) Inventors: Drew Bamford, Taoyuan County (TW); Micah Shotel, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: HTC CORPORATION, Taoyuan County (TW)

(21) Appl. No.: 12/399,988

(22) Filed: Mar. 9, 2009

(30) Foreign Application Priority Data
May 2, 2008 (TW) 97116194

(51) Int. Cl. G06F 3/048

(52) U.S. Cl. 715/702; 715/810

(57) ABSTRACT

A method and an apparatus for browsing item information and a recording medium using the same are provided. In the present application, a user interface is displayed in a touch screen of a portable electronic device, and an item icon bar is displayed at one side of the user interface, in which the item icon bar comprises item icons of one or multiple items of the user interface. Meanwhile, first item information corresponding to a first item icon among the item icons is displayed in the user interface. Then, a touch signal is detected through the touch screen. When the touch signal falls within the first item icon, an item information block is extended and displayed from the first item icon, and second item information corresponding to the first item icon is displayed in the item information block.

### CROSS-REFERENCE TO RELATED APPLICATION

This application claims the priority benefit of Taiwan application serial no. 97116194, filed May 2, 2008. The entirety of the above-mentioned patent application is hereby incorporated by reference herein and made a part of specification.

### BACKGROUND OF THE APPLICATION

1. Field of the Application

The present application generally relates to a data browsing method, and more particularly, to a method for displaying item information in a user interface according to a touch action of a user.

2. Description of Related Art

In order to catch up with the quick pace for the modern life of the mass, various portable electronic devices that can be conveniently taken along without occupying a large space have been increasingly developed. For example, a personal digital assistant (PDA) phone not only provides various functions of a conventional communication device, but also enables a user to write a document, send/receive E-mails, browse networks, or use instant messaging software through a built-in windows operation system. That is to say, the portable electronic device may not only be used to make a call, but further provide various diversified functions like a small personal computer. With the rapid progress of the wireless network technique, the applications of such functions are no longer limited by time and space. As for the modern people who stress on efficiency, such communication device has become one of the indispensable tools.

However, considering the outlay requirements for the portable electronic device of being light, thin, short, and small, the volume of the device is quite limited. If it intends to dispose both a screen and a keyboard on the device, the size of the screen has to be reduced. In order to configure a larger screen within a limited space, recently, a touch screen has been developed. The touch screen with a keyboard integrated therein serves as an input interface for the portable electronic device, so as to save the cost for configuring the conventional keyboard and reduce the occupied area.

However, the size of the touch screen on the portable electronic device is still limited. On the contrary, the functions of the portable electronic device are quite diversified. In order to present all this data in the limited screen, the data is usually listed one by one in a user interface to be browsed and inspected by a user. However, such a browsing method cannot present the data and related information thereof together in the screen. For example, there will be no space for displaying the shooting information of a photo if the entire photo is displayed in the screen. As described above, the conventional data browsing method is not very satisfactory.

### SUMMARY OF THE APPLICATION

Accordingly, the present application is directed to a method for browsing item information, wherein simplified item information is displayed according to a touch action of a user so that the time for reading item information can be saved.

The present application is directed to an apparatus for browsing item information, wherein an item icon bar is displayed at one side of a user interface and corresponding item information is displayed in an extended block of a selected item icon, so that the convenience in item information browsing is improved.

The present application provides a method for browsing item information, wherein the method is suitable for a portable electronic device having a touch screen. The method comprises following steps. First, a user interface is displayed in the touch screen, and an item icon bar is displayed at one side of the user interface, wherein the item icon bar comprises item icons of one or multiple items of the user interface. Then, first item information corresponding to a first item icon among foregoing item icons is displayed in the user interface. Finally, a touch signal is detected through the touch screen, wherein when the touch signal falls within the first item icon, an item information block is extended and displayed from the first item icon, and second item information corresponding to the first item icon is displayed in the item information block.

According to an embodiment of the present application, the step of extending the item information block from the first item icon when the touch signal falls within the first item icon comprises determining whether the touch signal stays in the first item icon for more than a predetermined time, wherein the item information block is displayed only when the touch signal stays in the first item icon for more than the predetermined time.

According to an embodiment of the present application, the item icon in the item icon bar on which the touch signal is located is enlarged when the touch signal falls within the item icon bar but stays therein for no longer than the predetermined time.

According to an embodiment of the present application, the step of extending the item information block from the first item icon comprises extending the item information block from the first item icon towards another side of the user interface.

According to an embodiment of the present application, the second item information is simplified information or partial information of the first item information, wherein the first item information comprises a contact information comprising a contact name, a contact photo, a contact phone number, or a contact e-mail address, a picture information comprising a picture or a picture file name, or a multimedia information comprising an image of a multimedia or a multimedia file name, and the second item information comprises the contact name, the contact photo, the picture, the picture filename, the image of the multimedia, or the multimedia file name.

According to an embodiment of the present application, after the step of extending the item information block, the method for browsing item information further comprises determining whether the touch signal is moved to another item icon, wherein when the touch signal is moved to the another item icon, the item information block is moved correspondingly to an extended area of the another item icon, and the second item information corresponding to the another item icon is displayed in the item information block.

According to an embodiment of the present application, the method for browsing item information further comprises extending the item information block from the item icon on which the touch signal is located towards another side of the user interface and displaying the second item information corresponding to the item icon in the item information block when the touch signal falls within an extended area corresponding to the item icons in the user interface and stays therein for more than a predetermined time.

According to an embodiment of the present application, the method for browsing item information further comprises determining a second item icon on which the touch signal is terminated and displaying the first item information corresponding to the second item icon in the user interface.

According to an embodiment of the present application, the method for browsing item information further comprises serving the extended area of the item icon as an interactive area of the touch signal before the step of determining whether the touch signal is moved to another item icon.

According to an embodiment of the present application, the method for browsing item information further comprises determining the extended area of a third item icon on which the touch signal is terminated and displaying the first item information corresponding to the third item icon in the user interface.

According to an embodiment of the present application, the step of extending the item information block comprises extending the item information block from the first item icon on which the touch signal is located towards a horizontal direction or a vertical direction.

According to an embodiment of the present application, the method for browsing item information further comprises displaying the first item information corresponding to a fourth item icon in the user interface when the touch signal falls within the fourth item icon other than the first item icon.

According to an embodiment of the present application, the item icons comprise a “contact” item icon or an “add contact” item icon.

According to an embodiment of the present application, the side mentioned above comprises the upper side, lower side, left side, or right side of the user interface, and the portable electronic device comprises a cell phone, a smartphone, or a personal digital assistant (PDA) phone.

The present application provides an apparatus for browsing item information. The apparatus comprises a touch screen, a user interface display module, an item icon bar display module, and an item information display module. The touch screen is used for detecting a touch signal of a user. The user interface display module is used for displaying a user interface in the touch screen, and the item icon bar display module is used for displaying an item icon bar at one side of the user interface, wherein the item icon bar comprises item icons of one or multiple items of the user interface. The item information display module is used for displaying first item information corresponding to a first item icon among foregoing item icons in the user interface and displaying second item information in the touch screen according to the touch signal detected by the touch screen. When the touch signal falls within the first item icon, the item information display module extends an item information block from the first item icon, and displays the second item information corresponding to the first item icon in the item information block, wherein the second item information comprises simplified information or partial information of the first item information.

According to an embodiment of the present application, the item information display module further determines whether the touch signal stays in the first item icon for more than a predetermined time, wherein the item information display module displays the item information block only when the touch signal stays in the first item icon for more than the predetermined time.

According to an embodiment of the present application, the item icon bar display module further enlarges the item icon in the item icon bar on which the touch signal is located when the touch signal falls within the item icon bar but stays therein for no longer than the predetermined time.

According to an embodiment of the present application, the item information display module extends the item information block from the first item icon towards another side of the user interface.

According to an embodiment of the present application, the item information display module further determines whether the touch signal is moved to another item icon after extending the item information block, wherein when the touch signal is moved to the another item icon, the item information display module moves the item information block correspondingly to an extended area of the another item icon and displays the second item information corresponding to the another item icon in the item information block.

According to an embodiment of the present application, the item information display module further determines a second item icon on which the touch signal is terminated and displays the first item information corresponding to the second item icon in the user interface.

According to an embodiment of the present application, the item information display module further serves the extended area of the item icon as an interactive area of the touch signal before determining whether the touch signal is moved to another item icon.

According to an embodiment of the present application, the item information display module further determines whether the touch signal is moved to the extended area of another item icon after extending the item information block, wherein when the touch signal is moved to the extended area of another item icon, the item information display module moves the item information block correspondingly to the extended area of the another item icon and displays the second item information corresponding to the another item icon in the item information block.

According to an embodiment of the present application, the item information display module extends the item information block from the first item icon on which the touch signal is located to a horizontal direction or a vertical direction.

The present application provides a recording medium for recording a computer program, wherein the computer program includes a plurality of program codes, which is suitable for being loaded into a portable electronic device to enable the portable electronic device to execute a method for browsing item information. The method comprises following steps. First, a user interface is displayed in a touch screen, and an item icon bar is displayed at one side of the user interface, wherein the item icon bar includes item icons of one or multiple items of the user interface. Then, first item information corresponding to a first item icon among foregoing item icons is displayed in the user interface. Finally, a touch signal is detected through the touch screen, wherein when the touch signal falls within the first item icon, an item information block is extended from the first item icon towards another side of the user interface, and second item information corresponding to the item icon is displayed in the item information block.

In the present application, an item icon bar is displayed at one side of a user interface, and an item information block is extended from an item icon according to a touch action of a user and used for displaying simplified item information. Thereby, the time for reading complete item information can be saved and the convenience in item information browsing can be improved.

### BRIEF DESCRIPTION OF THE DRAWINGS

The accompanying drawings are included to provide a further understanding of the application, and are incorporated in and constitute a part of this specification. The drawings illustrate embodiments of the application and, together with the description, serve to explain the principles of the application.

FIG. 1 is a disposition diagram of a user interface according to an embodiment of the present application.

FIG. 2 is a flowchart of an item information browsing method according to an embodiment of the present application.

FIG. 3 is a flowchart of an item information browsing method according to an embodiment of the present application.

FIG. 4(a), FIG. 4(b), and FIG. 4(c) are diagrams of an item information browsing method according to an embodiment of the present application.

FIG. 5(a), FIG. 5(b), and FIG. 5(c) are diagrams of an item information browsing method according to an embodiment of the present application.

FIG. 6 is a block diagram of an item information browsing apparatus according to an embodiment of the present application.

### DESCRIPTION OF THE EMBODIMENTS

Reference will now be made in detail to the present preferred embodiments of the application, examples of which are illustrated in the accompanying drawings. Wherever possible, the same reference numbers are used in the drawings and the description to refer to the same or like parts.

In order to provide a convenient method for a user to browse contacts, photos, and multimedia data in a limited screen space, in the present application, an item icon bar is displayed in a user interface for presenting foregoing data, and besides, a special block is extended from an item icon and displayed in the screen according to a touch action of a user for displaying simplified information of foregoing data. Thus, the user can get related information of the data roughly so that the speed and convenience in data browsing can be both increased. The present application provides a method and an apparatus for browsing item information and a recording medium using the same based on foregoing concepts. Embodiments of the present application will be described below with reference to accompanying drawings.

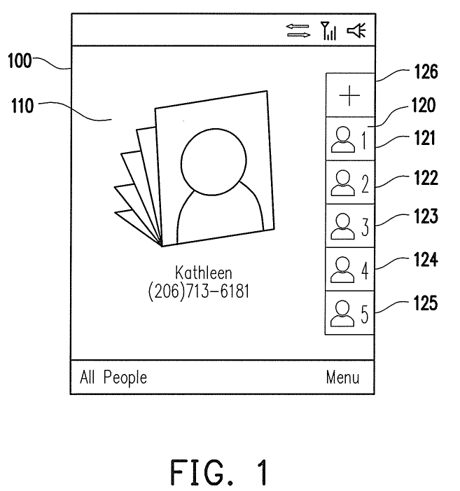

FIG. 1 is a disposition diagram of a user interface according to an embodiment of the present application. Referring to FIG. 1, in the present embodiment, a user interface 110 is displayed in a touch screen 100 of a portable electronic device, and meanwhile, an item icon bar 120 is displayed at the right side of the user interface 110. The item icon bar 120 comprises item icons of “contacts” 121˜125 and an item icon of “add contact” 126. These item icons respectively correspond to items in the user interface 110 and may be presented in a graphical pattern, for example, with photos of the contacts, thumbnails of pictures, or representative icons of multimedia files, so that a user can inspect or browse the content of each item directly.

Whenever the user enters the user interface 110, besides displaying the item icon bar 120 at the right side of the user interface 110, the portable electronic device also displays first item information of a particular item icon (for example, the contact 121) in the item icon bar 120 in the user interface 110, wherein the first item information comprises a contact information comprising a contact name, a contact photo, a contact phone number, or a contact e-mail address, a picture information comprising a picture or a picture file name, or a multimedia information comprising an image of a multimedia or a multimedia file name, etc. However, the content of the first item information in the present application is not limited thereto.

The present application provides an innovative method for browsing item information based on the structure of user interface and item icon bar described above, such that the user can browse various items in the user interface and obtains related information of these items instantly. This method will be described below with reference to an embodiment of the present application.

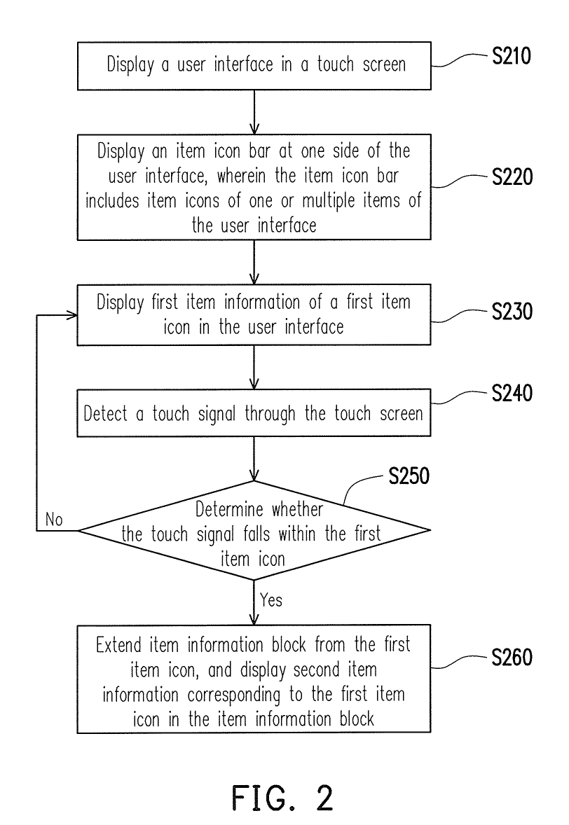

FIG. 2 is a flowchart of an item information browsing method according to an embodiment of the present application. Referring to FIG. 2, the present embodiment is suitable for a portable electronic device having a touch screen. The portable electronic device may be a cell phone, a smartphone, or a personal digital assistant (PDA) phone, but not limited to them.

First, the portable electronic device displays a user interface in the touch screen thereof (step S210). The user interface is corresponding to a particular function of the portable electronic device, and may be a preset user interface of the portable electronic device, a user interface appears when the user selects a particular function, or a user interface last operated by the user. It should be noted that the function mentioned above is a function which needs to browse multiple data, such as the function of phone book, contact list, message, e-mail, location information, photo, multimedia, bookmark, or webpage. However, the function in the present application is not limited thereto.

Next, the portable electronic device displays an item icon bar at one side of the user interface, in which the item icon bar comprises item icons representing a plurality of items of the user interface (step S220). The aforesaid side may be the upper side, lower side, left side, or right side of the user interface, which is not limited in the present application.

To be specific, the number of item icons in the item icon bar is determined according to the number of items in the built-in functions of the portable electronic device or according the number of the items selected from the items in the built-in function. The pattern of each item icon may be the pattern related to the item icon, for example, a photo of a contact can be used for representing this contact, such that the user can browse these items quickly.

Besides, the portable electronic device further displays first item information corresponding to a first item icon among foregoing item icons in the user interface (step S230). The first item information comprises contact information comprising a contact name, a contact photo, a contact phone number, or a contact e-mail address, picture information comprising a picture or a picture file name, or multimedia information comprising an image of a multimedia or a multimedia file name, etc. However, the present application is not limited thereto.

Thereafter, the portable electronic device detects a touch signal of the user through its touch screen (step S240) and determines whether the detected touch signal falls within the first item icon (step S250). If the touch signal falls within the first item icon, the portable electronic device extends an item information block from the first item icon and displays second item information corresponding to the first item icon in the item information block (step S260). In one embodiment, if the touch signal does not fall within the first item icon, the portable electronic device still displays the first item information corresponding to the first item icon in the user interface. In another embodiment, if the touch signal does not fall within the first item icon and falls within another item icon other than the first item icon, the portable electronic device extends an item information block from the another item icon and displays second item information corresponding to the another item icon in the item information block, and displays first item information of the anther item icon when the touch signal is terminated on the another item icon. In still another embodiment, if the touch signal does not fall within the first item icon and falls within another item icon other than the first item icon, the portable electronic device displays first item information of the anther item icon when the touch signal is terminated on the another item icon.

The portable electronic device may extend and display the item information block by stretching the item information block from the item icon on which the touch signal is located to a horizontal direction or a vertical direction. Besides, the second item information comprises, for example, contact information, picture information, or multimedia information, etc, and the first item information comprises, for example, the contact information and a contact photo, the picture information and a picture, or the multimedia information and an image of a multimedia. In other words, the second item information is only simplified information or partial information of the first item information. Thus, the time spent by the portable electronic device for reading the second item information is shorter than the time spent for reading the first item information. Accordingly, the portable electronic device can respond to a touch action of the user and display related item information in the screen quickly.

It should be noted that in another embodiment of the present application, step S250 further comprises calculating the time that the touch signal stays in the first item icon for and comparing this time with a predetermined time, wherein the item information block is displayed in the user interface only when the touch signal stays in the first item icon for more than the predetermined time. In short, the portable electronic device displays the item information block only after the user has pressed the first item icon for a certain time. In one embodiment, if the touch signal does not stay in the first item icon for more than the predetermined time, the item icon on which the touch signal is located in the item icon bar is enlarged for indicating which item icon is touched by the user.

According to yet another embodiment of the present application, the portable electronic device keeps detecting variations of the touch signal while it displays the item information block. When the touch signal is moved to another item icon, the portable electronic device correspondingly moves the item information block which originally corresponds to the first item icon to an extended area of the another item icon and displays the second item information corresponding to the another item icon in the item information block. This process will be described below with reference to an embodiment of the present application.

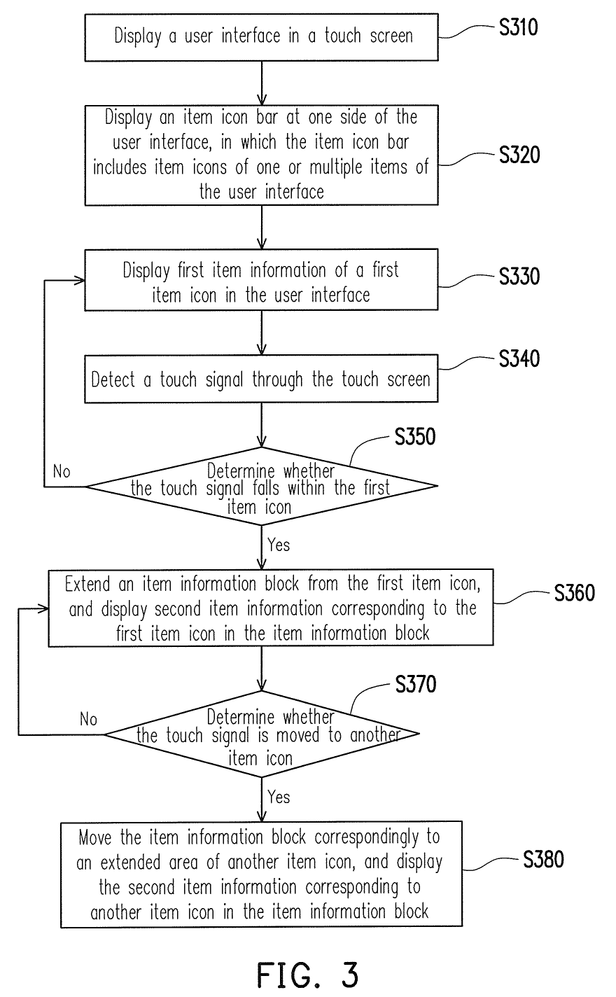

FIG. 3 is a flowchart of an item information browsing method according to an embodiment of the present application. Referring to FIG. 3, the present embodiment is suitable for a portable electronic device having a touch screen. The portable electronic device may be a cell phone, a smartphone, or a PDA phone, but is not limited thereto.

First, the portable electronic device displays a user interface in its touch screen (step S310) and displays an item icon bar at one side of the user interface, in which the item icon bar comprises item icons representing a plurality of items of the user interface (step S320). Meanwhile, the portable electronic device displays first item information corresponding to a first item icon among the item icons in the user interface (step S330).

After that, the portable electronic device detects a touch signal of the user through its touch screen (step S340) and determines whether the detected touch signal falls within the first item icon (step S350). If the touch signal falls within the first item icon, the portable electronic device extends an item information block from the first item icon and displays second item information corresponding to the first item icon in the item information block (step S360). In one embodiment, if the touch signal does not fall within the first item icon, the portable electronic device still displays the first item information corresponding to the first item icon in the user interface. In another embodiment, if the touch signal does not fall within the first item icon and falls within another item icon other than the first item icon, the portable electronic device extends an item information block from the another item icon and displays second item information corresponding to the another item icon in the item information block. Foregoing steps S310˜S360 are the same or similar to steps S210˜S260 in foregoing embodiment and therefore the detail thereof will not be repeated herein.

However, in the present embodiment, after step S360, the portable electronic device keeps detecting the variations of the touch signal and determines whether the touch signal is moved to another item icon (step S370). When the touch signal is moved to the another item icon, the portable electronic device moves the item information block correspondingly to an extended area of the another item icon and displays the second item information corresponding to the another item icon in the item information block (step S380). Accordingly, the user can move the item information block freely and browse the simplified information of different items through simple clicking and dragging actions.

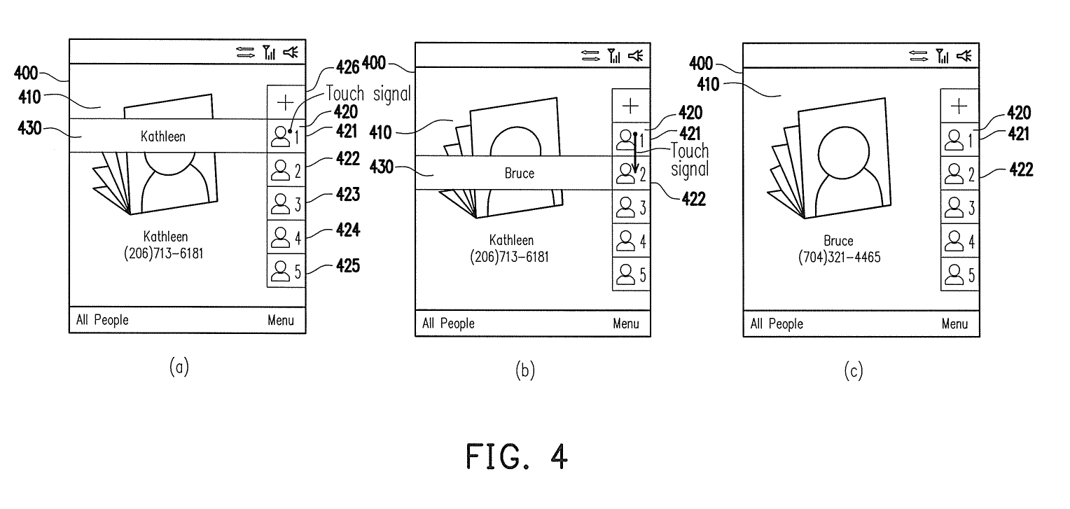

FIG. 4(a), FIG. 4(b), and FIG. 4(c) are diagrams of an item information browsing method according to an embodiment of the present application. Referring to FIG. 4(a) first, the disposition of user interface as shown in FIG. 1 is adopted in the present embodiment, namely, a user interface 410 is displayed in the touch screen 400, and an item icon bar 420 is displayed at the right side of the user interface 410, in which the item icon bar 420 comprises item icons of “contacts” 421425 and the “add contact” 426.

When the user presses the item icon of the contact 421, the portable electronic device extends an item information block 430 leftwards from the contact 421 and displays simplified information, such as the name, of the contact 421 in the item information block 430.

When the user presses the item icon of the contact 421 and drags his finger downwards, the portable electronic device moves the item information block downwards to an extended area of the contact 422 and changes the information displayed in the item information block 430 to the simplified information of the contact 422 (as shown in FIG. 4(b)).

In addition, when the user drags his finger to the item icon of the contact 422 and then releases his finger, namely, the touch signal is terminated on the item icon of the contact 422, the portable electronic device displays the detailed information, such as the name, phone number, and photo, of the contact 422 in the user interface 410 (as shown in FIG. 4(c)).

Besides switching the item information displayed in the user interface by touching and dragging within the item icon bar, in one embodiment of the present application, an extended area of each item icon is further served as an interactive area of the touch signal, namely, when the touch signal is moved to the extended area of another item icon, the item information block is correspondingly moved to the extended area of the another item icon and the second item information of the another item icon is displayed in the item information block. In short, the portable electronic device can still move the item information block according to the relative positions between the touch signal and the item icon bar even the user touches the first item icon and then drags his finger to outside of the item icon bar.

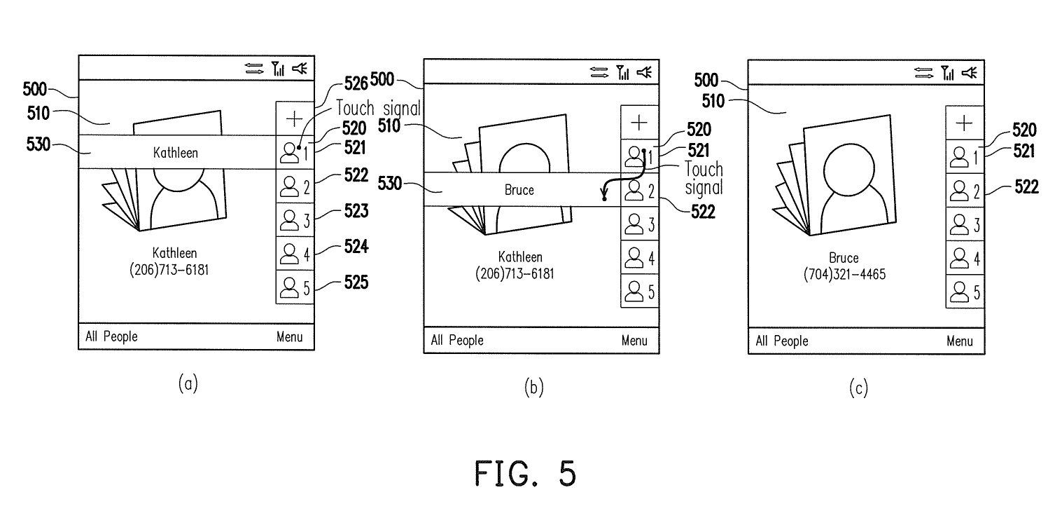

FIG. 5(a), FIG. 5(b), and FIG. 5(c) are diagrams of an item information browsing method according to an embodiment of the present application. Referring to FIG. 5(a), the disposition of the user interface illustrated in FIG. 1 is adopted in the present embodiment, namely, a user interface 510 is displayed in the touch screen 500, and a item icon bar 520 is also displayed at the right side of the user interface 510, in which the item icon bar 520 comprises item icons of “contacts” 521˜525 and the “add contact” 526.

When the user presses the item icon of the contact 521, the portable electronic device extends an item information block 530 leftwards from the contact 521 and displays simplified information, such as the name, of the contact 521 in the item information block 530.

When the user presses the item icon of the contact 521 and drags his finger downwards to the extended area of the item icon of the contact 522, the portable electronic device moves the item information block downwards to the extended area of the item icon of the contact 522 and changes the information displayed in the item information block 530 to the simplified information of the contact 522 (as shown in FIG. 5(b)).

In addition, when the user drags his finger to the extended area of the item icon of the contact 522 and then releases his finger, namely, the touch signal is terminated in the extended area of the item icon of the contact 522, the portable electronic device displays the detailed information, such as the name, phone number, and photo, of the contact 522 in the user interface 510 (as shown in FIG. 5(c)).

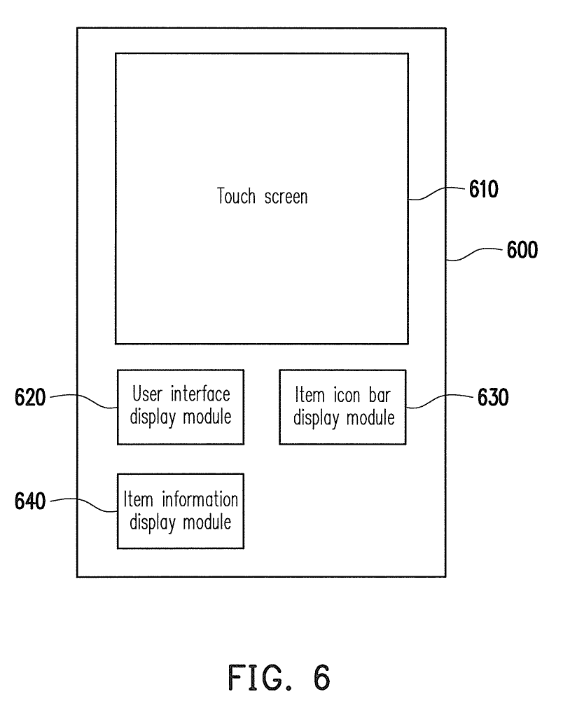

In another embodiment of the present application, the browsing method described above is further applied in an actual apparatus, which will be described in detail with reference to an embodiment of the present application. FIG. 6 is a block diagram of an item information browsing apparatus according to an embodiment of the present application. Referring to FIG. 6, the browsing apparatus 600 in the present embodiment may be disposed in a portable electronic device, such as a cell phone, a smartphone, or a PDA phone, in which the portable electronic device comprises a touch screen 610, a user interface display module 620, an item icon bar display module 630, and an item information display module 640. The functions of foregoing components will be respectively described below.

The touch screen 610 is used for detecting a touch action of the user and generating a corresponding touch signal. The user interface display module 620 is used for displaying a user interface in the touch screen 610, and the item icon bar display module 630 is used for displaying an item icon bar in the touch screen 610, in which the item icon bar comprises item icons of one or multiple items of the user interface.

The item information display module 640 is used for displaying first item information corresponding to a first item icon among foregoing item icons in the touch screen and displays second item information according to the touch signal detected by the touch screen 610. When the touch signal falls within the first item icon, the item information display module 640 extends an item information block from the first item icon towards another side of the user interface and displays the second item information corresponding to the first item icon in the item information block. The first item information comprises contact information comprising a contact name, a contact photo, a contact phone number, or a contact e-mail address, picture information comprising a picture or a picture file name, or multimedia information comprising an image of a multimedia or a multimedia file name, and the second item information comprises the contact name, the contact photo, the picture, the picture filename, the image of the multimedia, or the multimedia file name. As described above, the second item information can be considered as simplified information or partial information of the first item information.

Moreover, the item information display module 630 further detects whether the touch signal is moved to another item icon when it displays the item information block. When the touch signal is moved to the another item icon, the item information display module 630 correspondingly moves the item information block to the extended area of the another item icon and displays the second item information corresponding to the another item icon in the item information block.

It should be mentioned herein that when the touch signal is moved to the extended area of another item icon, the item information display module 630 also correspondingly moves the item information block to the extended area of the another item icon and displays the second item information corresponding to the another item icon in the item information block.

The present application further provides a recording medium (for example, a CD, a floppy disk, or a removable hard disk, etc), and the recording medium records a computer-readable permission approval program for executing foregoing item information browsing method. Herein the permission approval program recorded in the recording medium is usually composed of a plurality of code segments (for example, a code segment for establishing an organization chart, a code segment for approving a form, a configuration code segment, and a deployment code segment), and the functions of these code segments are corresponding to the steps of the item information browsing method and the functional block diagram of the item information browsing apparatus.

In overview, the present application provides a method and an apparatus for browsing item information and a recording medium using the same, in which an item icon bar is displayed at one side of a user interface and an item information block is extended from an item icon according to a touch action of a user for displaying simplified item information. Thereby, the time for reading complete item information is saved and the convenience in item information browsing is improved.

It will be apparent to those skilled in the art that various modifications and variations can be made to the structure of the present application without departing from the scope or spirit of the application. In view of the foregoing, it is intended that the present application cover modifications and variations of this application provided they fall within the scope of the following claims and their equivalents.

What is claimed is:

1. An item information browsing method, suitable for a portable electronic device having a touch screen, the item information browsing method comprising:
displaying a user interface in the touch screen;
displaying an item icon bar at one side of the user interface, wherein the item icon bar comprises item icons of one or multiple items of the user interface;
displaying first item information corresponding to a first item icon among the item icons in the user interface;
detecting a touch signal through the touch screen; and
extending an item information block from the first item icon when the touch signal falls within the first item icon, wherein second item information corresponding to the first item icon is displayed in the item information block.

2. The item information browsing method according to claim 1, wherein the step of extending the item information block from the first item icon when the touch signal falls within the first item icon comprises:
determining whether the touch signal stays in the first item icon for more than a predetermined time; and
displaying the item information block only when the touch signal stays in the first item icon for more than the predetermined time.

3. The item information browsing method according to claim 2, wherein when the touch signal falls within the item icon bar but stays in the item icon bar for no longer than the predetermined time, the item information browsing method further comprises:
enlarging the item icon in the item icon bar on which the touch signal is located.

4. The item information browsing method according to claim 1, wherein the step of extending the item information block from the first item icon comprises:
extending the item information block from the first item icon towards another side of the user interface.

5. The item information browsing method according to claim 1, wherein the second item information is simplified information or partial information of the first item information.

6. The item information browsing method according to claim 1, wherein the first item information and the second item information comprise contact information, picture information, or multimedia information.

7. The item information browsing method according to claim 1, wherein
the item icons comprise contact item icons;
the first item information comprises a contact photo, a contact name, and a contact phone number; and
the second item information comprises a contact name.

8. The item information browsing method according to claim 1, wherein item icons comprise an item icon for adding contact.

9. The item information browsing method according to claim 1, wherein after the step of extending the item information block, the item information browsing method further comprises:
determining whether the touch signal is moved to another item icon; and
moving the item information block correspondingly to an extended area of the another item icon and displaying the second item information corresponding to the another item icon in the item information block when the touch signal is moved to the another item icon.

10. The item information browsing method according to claim 9 further comprising:
determining a second item icon on which the touch signal is terminated; and
displaying the first item information corresponding to the second item icon in the user interface.

11. The item information browsing method according to claim 9, wherein before the step of determining whether the touch signal is moved to another item icon, the item information browsing method further comprises:
serving the extended area of the item icons as an interactive area of the touch signal;
determining whether the touch signal is moved to the extended area of another item icon; and
moving the item information block correspondingly to the extended area of another item icon and displaying the second item information corresponding to the another item icon in the item information block when the touch signal is moved to the extended area of the another item icon.

12. The item information browsing method according to claim 11 further comprising:
determining the extended area of a third item icon on which the touch signal is terminated; and
displaying the first item information corresponding to the third item icon in the user interface.

13. The item information browsing method according to claim 1 further comprising:
displaying the first item information corresponding to a fourth item icon in the user interface when the touch signal falls within a fourth item icon other than the first item icon.

14. An item information browsing apparatus, comprising:
a touch screen, for detecting a touch signal;
a user interface display module, for displaying a user interface in the touch screen;
an item icon bar display module, for displaying an item icon bar at one side of the user interface, wherein the item icon bar comprises item icons of one or multiple items of the user interface; and
an item information display module, for displaying first item information corresponding to a first item icon among the item icons in the user interface, and displaying second item information in the touch screen according to the touch signal detected by the touch screen, wherein the second item information is simplified information or partial information of the first item information; and wherein,
when the touch signal falls within the first item icon, the item information display module extends an item information block from the first item icon, and displays the second item information corresponding to the first item icon in the item information block.

15. The item information browsing apparatus according to claim 14, wherein the item information display module further determines whether the touch signal is moved to another item icon after extending the item information block, wherein when the touch signal is moved to the another item icon, the item information display module moves the item information block correspondingly to an extended area of the another item icon and displays the second item information corresponding to the another item icon in the item information block.

16. The item information browsing apparatus according to claim 15, wherein the item information display module further determines a second item icon on which the touch signal is terminated and displays the first item information corresponding to the second item icon in the user interface.

17. The item information browsing apparatus according to claim 14, wherein after extending the item information block, the item information display module further determines whether the touch signal falls within an extended area corresponding to another item icon in the user interface, and extends the item information block from the another item icon towards another side of the user interface and displays second item information corresponding to the item icon in the item information block when the touch signal falls within the extended area corresponding to the another item icon.

18. The item information browsing apparatus according to claim 17, wherein the item information display module further determines the extended area of a third item icon on which the touch signal is terminated and displays the first item information corresponding to the third item icon in the user interface.

19. The item information browsing apparatus according to claim 14, wherein the item information display module further displays the first item information corresponding to a fourth item icon in the user interface when the touch signal falls within the fourth item icon other than the first item icon.

20. A recording medium, for recording a computer program, wherein the computer program comprises a plurality of program codes, and the computer program is suitable for being loaded into a portable electronic device to enable the portable electronic device to execute the item information browsing method according to claim 1.
